(19) United States
(12) Patent Application Publication
(10) Pub. No.: US 2026/0106103 A1
(43) Pub. Date: Apr. 16, 2026

(54) CIRCUIT BREAKER AND BATTERY CONTROL SYSTEM INCLUDING THE CIRCUIT BREAKER

(71) Applicant: SAMSUNG SDI CO., LTD., Yongin-si (KR)

(72) Inventors: Seokbin YOON, Yongin-si (KR); Junho YOO, Yongin-si (KR); Nohyun KWAG, Yongin-si (KR); Jae-Seung KIM, Yongin-si (KR)

(21) Appl. No.: 19/184,095

(22) Filed: Apr. 21, 2025

(30) Foreign Application Priority Data
Oct. 16, 2024 (KR) 10-2024-0141581

(51) Int. Cl. H01H 71/02; H01H 71/08; H02H 7/18

(52) U.S. Cl. CPC H01H 71/0207; H01H 71/0264; H01H 71/08; H02H 7/18

(57) ABSTRACT

The present disclosure provides a circuit breaker and a battery control system including the circuit. The circuit breaker includes a frame including a lower frame and an upper frame, with an internal space being formed in the frame, a terminal portion disposed at a side of the frame to electrically connect the internal space of the frame and an exterior of the frame, and a terminal cover disposed at the side of the upper frame and covering the terminal portion.

### CROSS-REFERENCE TO RELATED APPLICATION

The present application claims priority to and the benefit of Korean Application No. 10-2024-0141581, filed on October 16, 2024, in the Korean Intellectual Property Office, the entire disclosure of which is incorporated by reference herein.

### BACKGROUND

### TECHNICAL FIELD

The present disclosure relates to a circuit breaker and a battery control system including the circuit breaker.

### DESCRIPTION OF THE RELATED ART

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An energy storage system (ESS) may connect renewable energy sources such as wind or solar power, whose power output cannot be controlled, to an existing power grid, and the ESS may charge or discharge the energy according to power consumption patterns. In particular, battery energy storage systems using secondary batteries may be used not only to stabilize grid voltage and frequency, but battery energy storage system may also store surplus energy in conjunction with renewable energy generation systems with unstable power generation, such as wind or solar power, and then supply energy to loads by discharging energy stored in the battery.

Among energy storage systems, uninterruptible power supplies (UPS) that require fast backup use high-power energy so that excessive current may be applied to internal components such as bus bars and battery modules during operation.

The above information disclosed in this Background section is for enhancement of understanding of the background of the present disclosure, and therefore, it may contain information that does not constitute related (or prior) art.

### SUMMARY

The present disclosure provides a circuit breaker and a battery control system including the circuit breaker. These and other aspects and features of the present disclosure will be described in or will be apparent from the following description of embodiments of the present disclosure. However, aspects and features of the present disclosure are not limited to those described above, and other aspects and features not mentioned will be clearly understood by a person skilled in the art from the detailed description, described below.

According to some embodiments of the present disclosure, a circuit breaker may include a frame including a lower frame and an upper frame, with an internal space being formed in the frame; a terminal portion disposed at a side of the frame to electrically connect the internal space of the frame and an exterior of the frame; and a terminal cover disposed at the side of the upper frame and covering the terminal portion.

According to some embodiments of the present disclosure, an upper surface of the upper frame may have an open area corresponding to the terminal portion, and the terminal cover may be disposed in the open area.

According to some embodiments of the present disclosure, the terminal cover may include a guide portion including a guide hole connected to the internal space of the frame, and a body portion extending from a side of the guide portion and covering the terminal portion, and the body portion, the side of the guide portion, and the upper frame may form an external appearance of the circuit breaker.

According to some embodiments of the present disclosure, the body portion may include a through hole penetrating the body portion and formed at a position corresponding to the terminal portion.

According to some embodiments of the present disclosure, the body portion may include a first fastening portion disposed adjacent to ends of a side of the body portion, and a second fastening portion disposed between the ends of the side of the body portion, and fastening members may be connected to the first fastening portion and the second fastening portion to fixedly connect the body portion and the upper frame.

According to some embodiments of the present disclosure, the side of the guide portion connected to the body portion may be formed to slope downward from the body portion.

According to some embodiments of the present disclosure, t a plurality of grooves may be formed along an inner surface of the guide portion adjacent to the guide hole.

According to some embodiments of the present disclosure, the terminal cover may include an insulating material.

According to some embodiments of the present disclosure , there is provided a circuit breaker including: a frame including a lower frame and an upper frame, with an internal space formed in the frame; a terminal portion exposed on a rear surface of the lower frame to electrically connect the internal space of the frame and an exterior of the frame; and a terminal cover disposed on the rear surface of the lower frame and covering the terminal portion.

According to some embodiments of the present disclosure, the terminal cover may include a guide portion including a guide hole connected to the internal space of the frame, and a body portion extending from a side of the guide portion and covering the terminal portion, and the guide hole may be disposed in a direction perpendicular to a rear surface of the lower frame.

According to some embodiments of the present disclosure, there is provided a battery control system including: a case including a front housing; a circuit breaker disposed within the case and including at least one terminal portion; a first housing penetration portion formed in the front housing such that the circuit breaker is exposed to outside of the housing; and a second housing penetration portion accessible to the terminal portion of the circuit breaker.

According to some embodiments of the present disclosure, a circuit breaker may include a frame including a lower frame and an upper frame, with an internal space being formed in the frame; a terminal portion disposed at a side of the frame to electrically connect the internal space of the frame and an exterior of the frame; and a terminal cover disposed on at least one side of the upper frame and covering the terminal portion.

According to some embodiments of the present disclosure, an upper surface of the upper frame may have an open area corresponding to the terminal portion, and the terminal cover may be disposed in the open area.

According to some embodiments of the present disclosure, the terminal cover may include a guide portion including a guide hole connected to the internal space of the frame, and a body portion extending from a side of the guide portion and covering the terminal portion.

According to some embodiments of the present disclosure, the side of the guide portion connected to the body portion may be formed to slope downward from the body portion.

According to some embodiments of the present disclosure, the guide hole of the guide portion may include a plurality of grooves formed along an inner surface.

According to some embodiments of the present disclosure, the body portion may include a through hole penetrating the body portion and formed at a position corresponding to the terminal portion, and the through hole may correspond to the second housing penetration portion.

According to some embodiments of the present disclosure, a screw may be positioned through the second housing penetration portion and the through hole.

According to some embodiments of the present disclosure, the battery control system may further include a third housing penetration portion formed in the front housing; and a bus bar disposed within the case, the bus bar being electrically connected to the circuit breaker, and the bus bar penetrating the third housing penetration portion so as to be connected to the third housing penetration portion.

According to embodiments of the present disclosure, the battery control system may further include a rack battery management system (BMS) disposed within the case, and a fuse disposed within the case and connected to the circuit breaker.

According to embodiments of the present disclosure, the safety of the energy storage system may be improved by cutting off the current by the circuit breaker when a current exceeding a predetermined amount.

According to embodiments of the present disclosure, torque and internal resistance may be measured through a screw fastened to a through hole of the terminal cover of the circuit breaker. Accordingly, the assembly of the battery control system may be improved.

According to embodiments of the present disclosure, the size of the frame of the circuit breaker may be reduced by the terminal cover of the circuit breaker, and the circuit breaker may be fixedly connected to the battery control system without separate additional parts. Accordingly, the production cost may be reduced.

According to embodiments of the present disclosure, an arc generated during an operation of the circuit breaker may be discharged through the terminal cover of the circuit breaker. Accordingly, safety may be improved when using a circuit breaker.

According to embodiments of the present disclosure, by adjusting the position of the terminal cover of the circuit breaker, the structure of an energy storage system using high-power energy may be freely designed.

However, aspects and features of the present disclosure are not limited to those described above, and other aspects and features not mentioned will be clearly understood by a person skilled in the art from the detailed description below.

### BRIEF DESCRIPTION OF DRAWINGS

The drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a diagram showing an energy storage system according to an embodiment of the present disclosure.

FIG. 2 is a diagram showing a power cut-off mechanism of a circuit breaker and a fuse according to an embodiment of the present disclosure.

FIG. 3 is a drawing showing the circuit breaker according to an embodiment of the present disclosure.

FIG. 4 is a drawing showing a terminal cover of the circuit breaker according to an embodiment of the present disclosure.

FIG. 5 is a drawing showing a circuit breaker according to an embodiment of the present disclosure.

FIG. 6 is an elevational view of an energy storage system including the circuit breaker depicted in FIG. 5.

FIG. 7 is a diagram showing an arc injection mechanism of the circuit breaker according to an embodiment of the present disclosure.

FIG. 8 is a diagram showing a battery control system according to an embodiment of the present disclosure.

FIG. 9 is a drawing showing a circuit breaker according to an embodiment of the present disclosure.

FIG. 10 is a diagram showing a battery control system according to an embodiment of the present disclosure.

FIG. 11 is a diagram showing a battery control system according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements. In addition, it will be understood that when a component is referred to as being "linked," "coupled," or "connected" to another component, the elements may be directly “coupled,” “linked” or "connected" to each other, or another component may be "interposed" between the components".

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

In the present disclosure, a battery rack may refer to an energy storage source including a plurality of battery modules that accommodate a plurality of secondary batteries electrically connected in series and/or in parallel. Additionally, in the present disclosure, a battery management system (BMS) may include a module BMS for managing a battery module and a rack BMS for managing a battery rack. The battery management system, which monitors the battery status and performs diagnosis and control, communication, and protection functions, may calculate the charge and discharge status and the battery life or state of health (SOH), cut off battery power (relay control) when necessary, control thermal management (cooling, heating, or the like), perform high-voltage interlock functions, and detect or calculate insulation and short-circuit state. The battery management system may include, for example, a detection device, a balancing device, and a control device. The detection device may detect status information indicating the status of the battery by detecting voltage, current, temperature, or the like of the battery. The balancing device may perform a balancing operation of the battery. The control device may receive battery status information (voltage, current, temperature, or the like) from the detection device. The control device may monitor and calculate the status (voltage, current, temperature, state of charge (SOC), state of health (SOH), or the like) of the battery based on the status information received from the detection device. In addition, the control device may perform control functions (for example, temperature control, balancing control, charge/discharge control, or the like), protection functions (for example, over-discharge protection, overcharge protection, overcurrent protection, short-circuit protection, extinguishing function, or the like), based on the status monitoring results. In addition, the control device may perform wired or wireless communication functions with an external device such as a higher level controller or PCS.

According to embodiments of the present disclosure, the control device may also control charging, discharging, and protection operations of the battery. As such, the control device may include a charge/discharge control unit, a balancing control unit, and a protection unit.

In the present disclosure, a circuit breaker, such as, a Molded Case Circuit Breaker (MCCB, may refer to a protection device that controls power supply to a battery rack between the battery rack and an external power device. In the present disclosure, the circuit breaker may be set to at least one of an “open state,” a “trip state” and a “closed state.” When the circuit breaker is in an open state, the circuit between the battery rack and the external power device is open, which cuts off the current supplied to the battery rack. Conversely, when the circuit breaker is in a closed state, the circuit between the battery rack and the external power device is closed, allowing current to be supplied to the battery rack. Additionally, when the circuit breaker is in a trip state, the circuit between the battery rack and the external power device may be opened, which interrupts the current supplied to the battery rack. However, unlike the open state, even when the trip state of the circuit breaker is released, the circuit breaker does not immediately switch to the closed state, but may be switched to the closed state through additional operations (for example, physical operations, or the like.). Additionally, when the trip state of the circuit breaker is released, the circuit breaker may be switched to the open state.

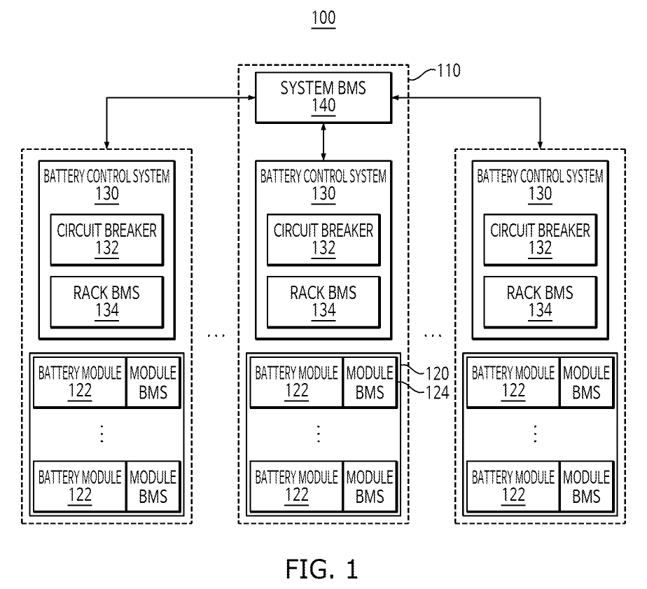

FIG. 1 is a diagram showing an energy storage system 100 according to an embodiment of the present disclosure. Referring to FIG. 1, the energy storage system 100 may include a container 110 including an accommodation space, a battery rack 120 disposed in the accommodation space of the container 110 and having a plurality of battery modules 122 stacked on top of each other, and a battery control system 130 connected to the battery rack 120. In one embodiment, the energy storage system 100 may be configured in a form in which a plurality of containers 110 each including a battery rack 120 and a battery control system 130 are disposed.

In an embodiment, the battery rack 120 may include at least one battery module 122 and a space for accommodating the at least one battery module 122. The battery module 122 may include a plurality of battery cells and a module housing. The plurality of battery cells may be stacked inside the module housing. Each of the battery cells may include a positive lead and a negative lead, and the battery cells may be of a circular type, a square type, or a pouch type.

In an embodiment, the battery rack 120 may include a module BMS 124 for managing the battery modules 122. The module BMS 124 may be connected to and manage the battery module 122.

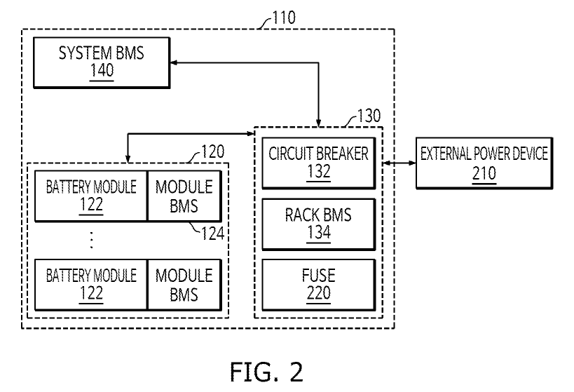

In an embodiment, the battery control system 130 may include a circuit breaker 132. Here, the circuit breaker 132 may cut off power to be supplied to the battery rack 120 and be positioned between the battery rack 120 and the external power device when necessary. A configuration in which the circuit breaker 132 is connected is described in detail below with reference to FIG. 2. The battery control system 130 may further include a rack BMS 134 for managing the battery rack 120.

In an embodiment, the energy storage system 100 may further include a system BMS 140 in the interior accommodation space of the container 110. For example, the system BMS 140 may be accommodated in the internal storage space of one of the plurality of containers 110 constituting the energy storage system 100, and the system BMS 140 may be connected to the battery rack 120 and battery control system 130 of each of the plurality of containers 110. However, in other embodiments, the system BMS 140 may be installed outside the containers 110 and be connected to the battery rack 120 and battery control system 130 of each of the plurality of containers 110. The system BMS 140 may receive voltage information or the like related to the battery rack 120 from the rack BMS 134 and manage the battery rack 120. Additionally, the system BMS 140 may determine the status of the circuit breaker 132 based on voltage information related to the battery rack 120. The system BMS 140 and the rack BMS 134 may transmit and receive information using, for example, controller area network (CAN) communication. The system BMS 140 may control the circuit breaker 132 through the rack BMS 134. In an embodiment, the system BMS 140 may receive voltage information or the like related to the plurality of battery racks 120 from the plurality of rack BMSs 134 such that the BMS 140 can manage the plurality of battery racks 120.

FIG. 2 is a diagram showing a power cut-off mechanism of the circuit breaker 132 and a fuse 220 according to an embodiment of the present disclosure. Referring to FIG. 2, the circuit breaker 132 in the battery control system 130 is disposed between the battery rack 120 and an external power device 210 to cut off power supply to the battery rack 120 when necessary. For example, when a problem occurs in an energy storage system such as shown in FIG. 1 and the current flowing to the battery rack 120 needs to be cut off, the circuit breaker 132 may open the line through which power is supplied from the external power device 210 to the battery rack 120 to thereby cut off the power supply. In an embodiment, when a problem with the energy storage system is resolved, the circuit breaker 132 may receive a command from the rack BMS 134 and/or the system BMS 140 to close the line through which power is supplied from the external power device 210 to the battery rack 120 to thereby resume power supply to the battery rack 120.

In an embodiment, the battery control system 130 may further include a fuse 220. Here, the fuse 220 is disposed between the battery rack 120 and the external power device 210 to control power supply to the battery rack 120. For example, when a current exceeding a predetermined threshold flows through the energy storage system, the fuse 220 may be ruptured by heat generated by the current, thereby cutting off power supply to the battery rack 120. The threshold of current causing the fuse to rupture may be greater than the threshold of current required for the circuit breaker 132 to cut off power to be supplied to the battery rack 120. In an embodiment, the system BMS 140 may determine the state of the circuit breaker 132 such that the circuit breaker 132 closes the line supplying power from the external power device 210 to the battery rack 120 at a time when the fuse 220 is not damaged.

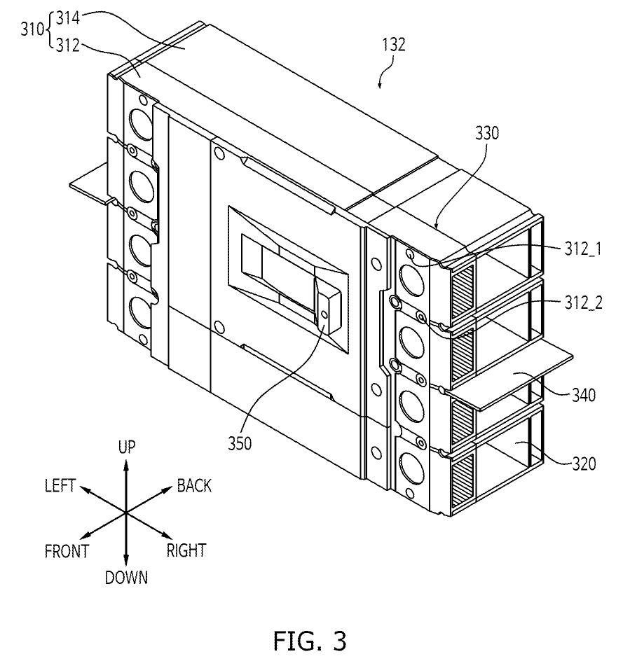

FIG. 3 shows the circuit breaker 132 according to an embodiment of the present disclosure. Referring to FIG. 3, the circuit breaker 132 may include a frame 310 including an upper frame 312 and a lower frame 314, and the circuit breaker 132 may have a space formed therein. A terminal portion 320 may be disposed on at least one side of the frame 310 to electrically connect the internal space of the frame 310 and the exterior of the frame 310, and a terminal cover 330 may be disposed on at least one side of the upper frame 312 and covering the terminal portion 320.

The frame 310 may form the outer shape of the circuit breaker 132 by positioning the upper frame 312 on the lower frame 314. A predetermined space may be formed inside the frame 310. In the internal space of the frame 310, a component for electrically connecting the inside and outside of the circuit breaker 132 and for cutting off power when necessary may be mounted. Thus, the frame 310 may function as a housing for the circuit breaker 132. Further, a component for extinguishing an arc generated when power is cut off may be mounted on the frame 310.

The frame 310 may include a heat-resistant material. Accordingly, heat generated inside the frame 310 may be contained to thereby prevent damage to structures outside the frame 310. The frame 310 also may include an insulating material. Accordingly, the inside and outside of the frame 310 may not be energized. In example embodiments, the frame 310 may include at least one of a synthetic resin or a reinforced plastic. However, the present disclosure is not limited in this regard, the frame 310 may further include any material having heat resistance. In the illustrated embodiment, the frame 310 is formed to have a rectangular cross-section having a length in the left-right direction that is longer than a length in the up-down direction. Additionally, the frame 310 may extend in the front-back direction to a predetermined length. Accordingly, the frame 310 has a rectangular parallelepiped shape such that a plurality of circuit breakers 132 may be easily disposed in the vertical direction. However, the shape of the frame 310 may include any shape that may accommodate components inside that allow or cut off current flow between the inside and the outside.

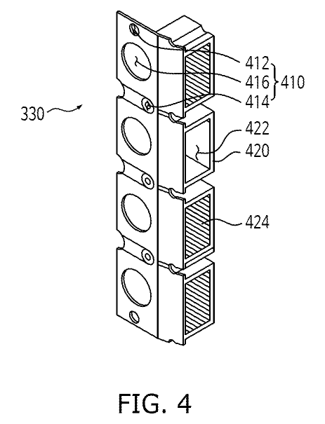

The upper frame 312 may be disposed on the lower frame 314 to form the appearance of the frame 310. Based on the directions of the coordinate axes illustrated in FIG. 3, the surface that contacts the lower frame 314 in the front-back direction may be referred to as the rear surface of the upper frame 312, and the surface that faces the lower surface of the upper frame 312 in the front-back direction may be referred to as the front surface of the upper frame 312. Here, an area corresponding to the terminal portion 320 is opened on the front surface of the upper frame 312, and the terminal cover 330 may be disposed in the opened area. As described in detail below with reference to FIG. 4, the upper frame 312 may further include a trench or groove 312_1, 312_2 such that the upper frame 312 may be fixed and connected to the terminal cover 330.

The terminal portion 320 may electrically connect the internal space and the exterior of the frame 310. The terminal portion 320 may be electrically connected to each component accommodated in the internal space of the frame 310, and the terminal portion 320 may be electrically connected to an external power device 210 as shown in FIG. 2. The terminal portion 320 may include a conductive material such as copper Cu. A plurality of terminal portions 320 may be provided.

The terminal cover 330 may form the appearance of the circuit breaker 132 together with the upper frame 312. The terminal cover 330 may be disposed on one side of the upper frame 312, or on both sides to cover an area corresponding to the terminal portion 320. The terminal cover 330 may include an insulating material. In some examples, the terminal cover 330 may include the same insulating material as the frame 310. The detailed configuration and function of the terminal cover 330 will be described below with reference to FIG. 4.

In an embodiment, the circuit breaker 132 may further include an insulating plate 340. The circuit breaker also may include a plurality of terminal portions 320. In the illustrated embodiment, four terminal portions 320 are formed on one side of the circuit breaker 132. Here, two terminal portions 320 may be electrically connected to a positive electrode, and the remaining two terminal portions 320 may be electrically connected to a negative electrode. The insulating plate 340 is disposed between the terminal portions 320 connected to the positive and negative electrodes to prevent short circuits caused by contact between components electrically connected to the terminal portions 320. The insulating plate 340 may include the same insulating material as the frame 310.

In an embodiment, the circuit breaker 132 may further include a lever 350. The lever 350 may allow or cut off current from flowing to the circuit breaker 132. In the illustrated embodiment, the lever 350 rotates in the left and right directions. The lever 350 is rotatably connected to the upper frame 312. The lever 350 may be connected to various components inside the frame 310 for performing a trip operation. Thus, as the lever 350 rotates, the circuit breaker 132 may perform a trip operation.

FIG. 4 is a drawing showing the terminal cover 330 of the circuit breaker according to the an embodiment of the present disclosure. Referring to FIGS. 3 and 4, the terminal cover 330 may include a guide portion 420 including a guide hole 422 connected to the internal space of the frame 310, and a body portion 410 extending from the one side of the guide portion 420. In an embodiment, the body portion 410 may cover the terminal portion 320. The side of the body portion 410 and the guide portion 420 may form the appearance of the circuit breaker 132 together with the upper frame 312.

The body portion 410 may include a first fastening portion 412 disposed adjacent to ends of a side of the body portion 410 and a second fastening portion 414 disposed the ends of the side. Fastening means are connected to the first fastening portion 412 and the second fastening portion 414 to fixedly connect the body portion 410 and the upper frame 312. The fastening means may include, for example, bolts or screws. Here, to enable the body portion 410 and the upper frame 312 to be more easily fixedly connected, a trench or groove 312_1, 312_2 having a shape corresponding to the shape of the first fastening portion 412 and the second fastening portion 414 may be formed in the upper frame 312. In this way, the size of the frame 310 of the circuit breaker 132 may be reduced by the terminal cover 330. Also, because the circuit breaker 132 may be fixedly connected to the battery control system without additional parts, the production cost may be reduced.

The body portion 410 may include a through hole 416 that penetrates the body portion 410 and is formed at a position corresponding to the terminal portion 320. In the illustrated embodiment, the through hole 416 is formed in a circular shape, but the present disclosure is not limited thereto, and the through hole 416 may be formed in various shapes such as a polygon. The size of the through hole 416 may be larger than the sizes of the first fastening portion 412 and the second fastening portion 414. As will be described in detail below, according to an embodiment, torque and internal resistance may be measured through a screw fastened to the through hole 416 of the terminal cover 330.

In an embodiment, one side of the guide portion 420 connected to the body portion 410 may be formed to slope downward from the body portion 410. The guide hole 422 of the guide portion 420 may include a plurality of grooves 424 formed along the inner surface. The body portion 410 and the guide portion 420 of the terminal cover 330 may be formed in a number corresponding to the number of terminal portions 320 of the circuit breaker 132. With such a configuration, an arc generated when the circuit breaker 132 operates may be discharged through the guide hole 422 of the terminal cover 330 of the circuit breaker 132. Accordingly, s the circuit breaker 132 is made safer.

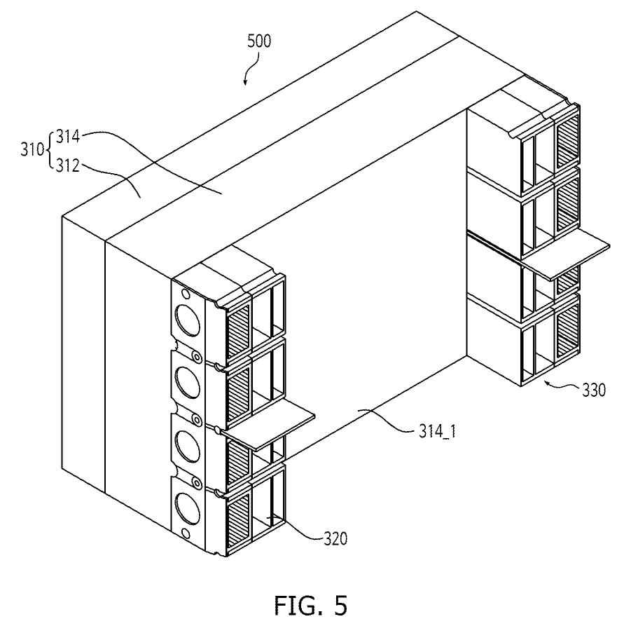

FIG. 5 is a drawing showing a circuit breaker 500 according to an embodiment of the present disclosure. Referring to FIG. 5, a circuit breaker 500 may include a frame 310 including an upper frame 312 and a lower frame 314, with a space formed in the frame 310. A terminal portion 320 is exposed on a back surface 314_1 of the lower frame 314 to electrically connect the internal space of the frame 310 and the exterior of the frame. A terminal cover 330 is disposed on the back surface 314_1 of the lower frame 314 to cover the terminal portion 320. The configuration of the upper frame 312, the lower frame 314, the terminal portion 320, and the terminal cover 330 of the circuit breaker 500 according to the embodiment illustrated in FIG. 5 is of the same as the upper frame 312, the lower frame 314, the terminal portion 320, and the terminal cover 330 of the circuit breaker 132 illustrated in FIGS. 3 and 4, except for the arrangement relationship of the terminal cover 330.

Referring to FIGS. 4 and 5, the guide hole 422 of the terminal cover 330 of the circuit breaker 500 may be disposed in a direction perpendicular to the back surface 314_1 of the lower frame 314.

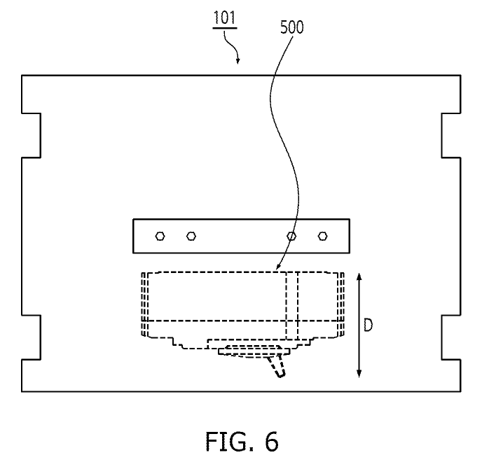

FIG. 6 is an elevational view of an energy storage system 101 including the circuit breaker 500 depicted in FIG. 5 . Referring to FIG. 6, the energy storage system 101 may be configured in the same manner as the energy storage system 100 illustrated in FIG. 1, except for the circuit breaker 500. Referring to FIG. 5, by arranging the terminal portion 320 and terminal cover 330 of the circuit breaker 500 on the back surface 314_1 of the lower frame 314, the size of the circuit breaker 500 may be increased in the depth direction D of the energy storage system 101. That is, the size of the energy storage system 101 in which high-power energy is used may be increased in the depth direction D of the energy storage system 101. Accordingly, the structure of the energy storage system 101 may be more freely designed.

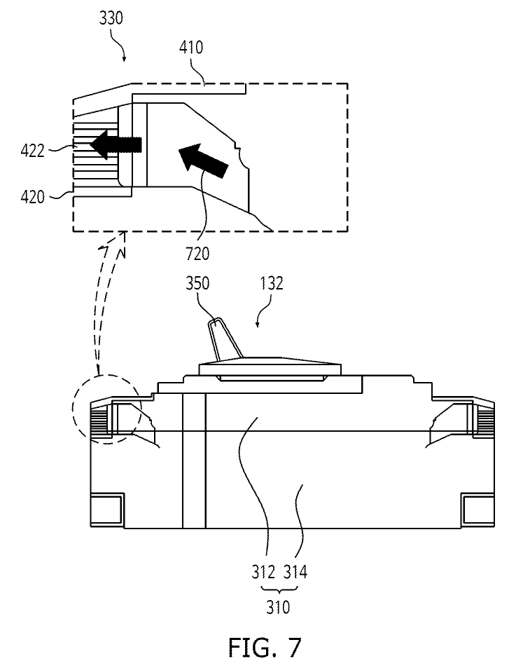

FIG. 7 is a diagram showing an arc 720 injection mechanism of the circuit breaker 132 according to an embodiment of the present disclosure. Referring to FIG. 7, an arc 720 may occur in the internal space of the frame 310 as the circuit breaker 132 performs a trip operation. Here, the terminal cover 330 is disposed on at least one side of the frame 310, so that the body portion 410 of the terminal cover 330 may prevent the arc 720 from being discharged toward the front surface of the upper frame 312. Thus, the arc 720 may be discharged in the direction of the arrow along the guide hole 422 of the guide portion 420. In this case, the side of the guide portion 420 connected to the body portion 410 is formed to slope downward from the body portion 410, so that the discharge of the arc 720 to the front surface of the circuit breaker 132 may be minimized. Accordingly, the circuit breaker 132 is made safer.

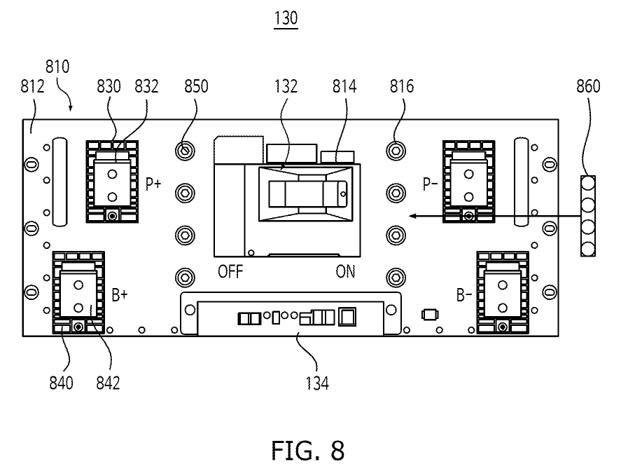

FIG. 8 is a diagram showing a battery control system 130 according to an embodiment of the present disclosure. Referring to FIG. 8, the battery control system 130 may include a case 810 including a front housing 812 forming a front surface, a circuit breaker 132 disposed within the case 810 and including at least one terminal portion, a first housing penetration portion 814 formed in the front housing 812 such that the circuit breaker 132 is exposed to outside of the battery control system 130, and a second housing penetration portion 816 accessible to the terminal portion of the circuit breaker 132.

In an embodiment, a space may be formed inside the case 810. In the internal space of the case 810, the battery control system 130 may be mounted with components for electrically connecting an external power device and a battery module or battery rack of an energy storage system, managing the battery module or battery rack, and disconnecting the connection with the external power device when necessary. That is, the case 810 may function as a housing. A first bus bar 832 and a second bus bar 842 for electrically connecting an external power device and an energy storage system may be mounted in the case 810.

The case 810 may be formed from a heat-resistant material. Accordingly, damage caused by heat generated inside the case 810 may be prevented. The case 810 also may include an insulating material. Accordingly, the inside and outside of the case 810 may not be energized. In some examples, the case 810 may include at least one of a synthetic resin or a reinforced plastic. The case 810 may be formed any shape to accommodate components inside and allow or cut off current flow between inside and outside of the case 810.

In an embodiment, the circuit breaker 132 may have the same configuration as the circuit breaker 132 illustrated in FIGS. 3 and 4. Accordingly, a detailed description of the circuit breaker 132 is omitted. The circuit breaker 132 may be mounted in the battery control system 130 such that at least a portion of it is the circuit breaker 132 is exposed to outside of the battery control system 130 by the first housing penetration portion 814.

Referring again to FIGS. 3 and 4, in an embodiment the battery control system 130 may include a terminal portion 320 of the circuit breaker 132 and an accessible second housing penetration portion 816. Here, a terminal cover 330 may be disposed between the second housing penetration portion 816 and the terminal portion 320. The terminal cover 330 may include the through hole 416 that penetrates the body portion 410 of the terminal cover 330, with the through hole 416 being formed at a position corresponding to the terminal portion 320. The through hole 416 may also correspond to the second housing penetration portion 816. A screw 850 may be fastened through the second housing penetration portion 816 and through hole 416. Torque and internal resistance may be measured from outside of the battery control system 130 through a screw 850 fastened to the through hole 416 of the terminal cover 330 of the circuit breaker 132. Accordingly, the assembly of the battery control system 130 may be improved. In an embodiment, the size of the frame 310 of the circuit breaker 132 may be reduced by the terminal cover 330 of the circuit breaker 132, and the circuit breaker 132 may be fixedly connected to the battery control system 130 without any additional parts. Accordingly, the production cost of the system may be reduced.

In an embodiment, the battery control system 130 may further include a third housing penetration portion 830 formed in the front housing 812. The first bus bar 832 may be disposed within the case 810, electrically connected to the circuit breaker 132, and penetrate the third housing penetration portion 830 to be connected to the third housing penetration portion 830. The first bus bar 832 may electrically connect the negative pole (B-) of a battery module and the positive pole (P+) of an external power device to the battery control system 130. The battery control system 130 may further include a fourth housing penetration portion 840 formed in the front housing 812. The second bus bar 842 may be disposed within the case 810, electrically connected to the circuit breaker 132, and penetrate the fourth housing penetration portion 840 to be connected to the fourth housing penetration portion 840. The second bus bar 842 may electrically connect the positive pole (B+) of the battery module and the negative pole (P-) of the external power device to the battery control system 130. Of course, the opposite to the configurations described herein is also possible.

In an embodiment, the battery control system 130 may further include a rack BMS 134. Because the configuration and function of the rack BMS 134 have been described in detail in FIG. 1, or the like, a detailed description of the rack BMS 134 is omitted here.

In an embodiment, the battery control system 130 may include a cover 860 covering the second housing penetration portion 816. The cover 860 may be formed so as to correspond to the number and shape of the second housing penetration portions 816 formed on the front housing 812. The cover 860 may be formed from the same insulating material as the case 810.

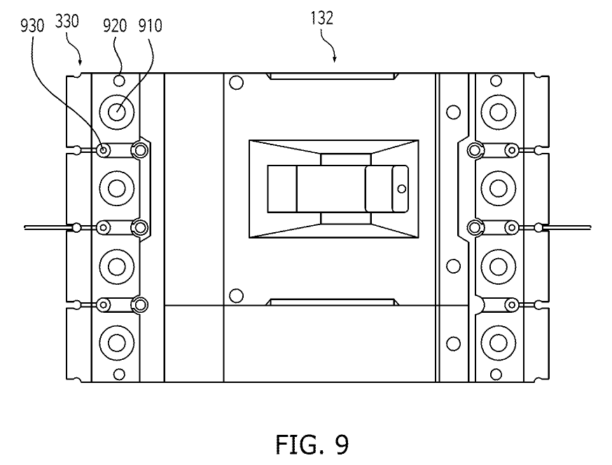

FIG. 9 shows the circuit breaker 132 according to an embodiment of the present disclosure. Referring to FIG. 9, a first screw 910, a second screw 920, and a third screw 930 may be fastened to the terminal cover 330 of the circuit breaker 132. Referring to FIGS. 4 and 8 together, the first screw 910 may be fastened by penetrating the through hole 416 formed in the circuit breaker 132. The first screw 910 may have the same configuration as the screw 850 that is fastened by penetrating the second housing penetration portion 816 of the battery control system 130. The second screw 920 may be fastened by penetrating the first fastening portion 412 as a fastening means. The third screw 930 may be fastened by penetrating the second fastening portion 414 as a fastening means. A circuit breaker 132 may be fixedly connected to the battery control system 130 in the same manner as described above.

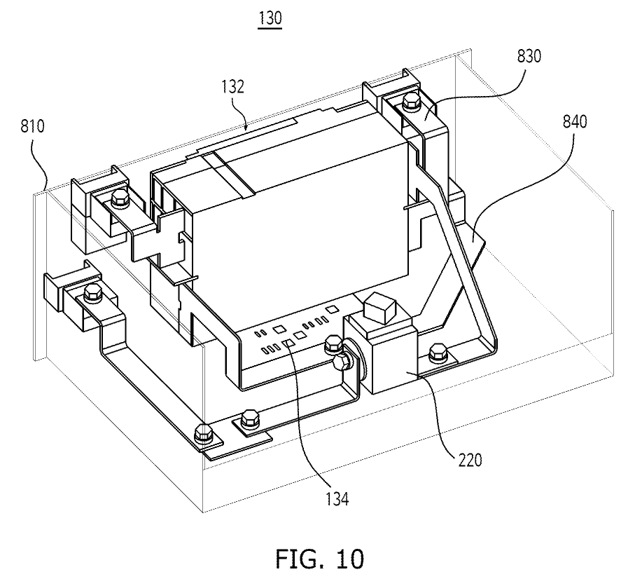

FIG. 10 is a diagram showing the battery control system 130 according to the one embodiment of the present disclosure. Referring to FIG. 10, the battery control system 130 may include a fuse 220 disposed within the case 810. The circuit breaker 132 and fuse 220 of the battery control system 130 cut off power based on different current thresholds so that the energy storage system connected to the battery control system 130 may be effectively protected from overcurrent or the like.

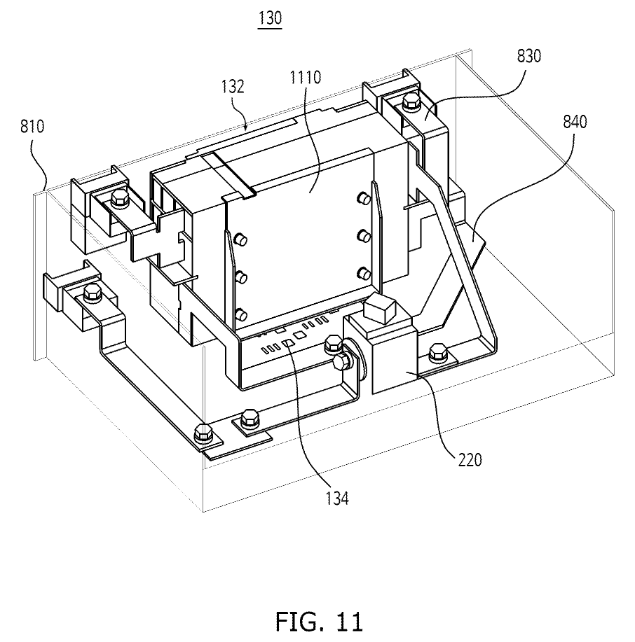

FIG. 11 is a diagram showing the battery control system 130 according to an embodiment of the present disclosure. Referring to FIG. 11, the battery control system 130 may further include a holder 1110 disposed on the back surface of the circuit breaker 132. The holder 1110 may stably fix the circuit breaker 132.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A circuit breaker comprising:
a frame comprising a lower frame and an upper frame, with an internal space being formed in the frame;
a terminal portion disposed on at least one side of the frame to electrically connect the internal space of the frame and an exterior of the frame; and
a terminal cover disposed on the least one side of the upper frame and covering the terminal portion.

2. The circuit breaker according to claim 1, wherein an upper surface of the upper frame has an open area corresponding to the terminal portion, and the terminal cover is disposed in the open area.

3. The circuit breaker according to claim 1, wherein the terminal cover comprises:
a guide portion comprising a guide hole connected to the internal space of the frame, and
a body portion extending from a side of the guide portion and covering the terminal portion, and
wherein the body portion, the side of the guide portion, and the upper frame form an external appearance of the circuit breaker.

4. The circuit breaker according to claim 3, wherein the body portion comprises a through hole penetrating the body portion and formed at a position corresponding to the terminal portion.

5. The circuit breaker according to claim 3, wherein the body portion comprises:
a first fastening portion disposed adjacent to ends of a side of the body portion, and
a second fastening portion disposed between the ends of the side of the body portion, and
wherein the body portion and the upper frame are fixedly connected through fastening members connecting the first fastening portion and the second fastening portion.

6. The circuit breaker according to claim 3, wherein the side of the guide portion connected to the body portion is formed to slope downward from the body portion.

7. The circuit breaker according to claim 3, wherein a plurality of grooves are formed along an inner surface of the guide hole of the guide portion.

8. The circuit breaker according to claim 1, wherein the terminal cover comprises an insulating material.

9. A circuit breaker comprising:
a frame comprising a lower frame and an upper frame, with an internal space being formed in the frame;
a terminal portion exposed on a rear surface of the lower frame to electrically connect the internal space of the frame and an exterior of the frame; and
a terminal cover disposed on a rear surface of the lower frame and covering the terminal portion.

10. The circuit breaker according to claim 9, wherein the terminal cover comprises:
a guide portion comprising a guide hole connected to the internal space of the frame, and
a body portion extending from a side of the guide portion and covering the terminal portion, and
wherein the guide hole is disposed in a direction perpendicular to a rear surface of the lower frame.

11. A battery control system comprising:
a case comprising a front housing;
a circuit breaker disposed within the case and comprising at least one terminal portion;
a first housing penetration portion formed in the front housing such that the circuit breaker is exposed to outside of the housing; and
a second housing penetration portion accessible to the terminal portion of the circuit breaker.

12. The battery control system according to claim 11, wherein the circuit breaker comprises:
a frame comprising a lower frame and an upper frame, with an internal space being formed in the frame,
a terminal portion disposed on at least one side of the frame to electrically connect the internal space of the frame and an exterior of the frame; and
a terminal cover covering the terminal portion.

13. The battery control system according to claim 12, wherein an upper surface of the upper frame has an open area corresponding to the terminal portion, and the terminal cover is disposed in the open area.

14. The battery control system according to claim 12, wherein the terminal cover comprises:
a guide portion comprising a guide hole connected to the internal space of the frame, and
a body portion extending from a side of the guide portion and covering the terminal portion.

15. The battery control system according to claim 14, wherein the side of the guide portion connected to the body portion is formed to slope downward from the body portion.

16. The battery control system according to claim 14, wherein the guide hole of the guide portion comprises a plurality of grooves formed along an inner surface.

17. The battery control system according to claim 14, wherein the body portion comprises a through hole penetrating the body portion and formed at a position corresponding to the terminal portion, and the through hole corresponds to the second housing penetration portion.

18. The battery control system according to claim 17, wherein a screw is positioned through the second housing penetration portion and the through hole.

19. The battery control system according to claim 11, further comprising:
a third housing penetration portion formed in the front housing; and
a bus bar disposed within the case, the bus bar being electrically connected to the circuit breaker, and the bus bar penetrating the third housing penetration portion so as to be connected to the third housing penetration portion.

20. The battery control system according to claim 19, further comprising a fuse disposed within the case.
